(19) United States
(12) Patent Application Publication
(10) Pub. No.: US 2026/0036545 A1
(43) Pub. Date: Feb. 5, 2026

(54) METHOD FOR OPERATING A SENSOR FOR DETECTING AT LEAST ONE PROPERTY OF A MEASURED GAS IN A MEASUREMENT GAS CHAMBER

(71) Applicant: Robert Bosch GmbH, Stuttgart (DE)

(72) Inventors: Fabian Weisser, Holzgerlingen (DE); Bernhard Ledermann, Weil Der Stadt (DE)

(21) Appl. No.: 18/994,791

(22) PCT Filed: Jul. 10, 2023
(86) PCT No.: PCT/EP2023/068961

§ 371 Date: Jan. 15, 2025

(30) Foreign Application Priority Data
Aug. 25, 2022 (DE) 10 2022 208 780.1

(51) Int. Cl. G01N 27/416

(52) U.S. Cl. CPC G01N 27/4163

(57) ABSTRACT

A method for operating a sensor for detecting at least one property of a measured gas in a measurement gas chamber. The method includes: measuring a Nernst voltage of the Nernst cell, and, based on the Nernst voltage, quantitatively determining a target variable describing the property of the measured gas; recording a target variable data packet based on the target variable; assigning a current timestamp to the target variable data packet; processing the target variable data packet on a signal processing path; requesting a current system time; correcting the timestamp of the currently processed target variable data packet based on a predetermined time delay and the current system time; converting the corrected timestamp to form a number of measured values; ascertaining a time correction index for the target variable based on the number of measured values; and ascertaining a corrected target variable value based on the time correction index.

### BACKGROUND INFORMATION

The related art describes a plurality of sensors and methods for detecting at least one property of a measured gas in a measurement gas chamber. In principle, the properties may be any physical and/or chemical properties of the measured gas, wherein one or more properties can be detected. The present invention is described below in particular with reference to a qualitative and/or quantitative detection of a fraction of a gas component of the measured gas, in particular with reference to a detection of an oxygen fraction in the measured gas portion. For example, the oxygen fraction may be detected in the form of a partial pressure and/or in the form of a percentage. However, alternatively or additionally, other properties of the measured gas are also detectable, for example the temperature.

The related art in particular describes ceramic sensors based on the use of electrolytic properties of certain solids, i.e., on ion-conductive properties of these solids. In particular, these solids may be ceramic solid electrolytes, such as zirconium dioxide (ZrO), in particular yttrium-stabilized zirconium dioxide (YSZ) and scandium-doped zirconium dioxide (ScSZ), which may contain low additions of aluminum oxide (Al₂O₃) and/or silicon oxide (SiO).

For example, such sensors may be designed as so-called lambda probes or as nitrogen oxide sensors, such as are described, for example, in K. Reif, Deitsche, K-H. et al., Kraftfahrtechnisches Taschenbuch [Automotive Handbook], Springer Vieweg, Wiesbaden, 2014, pages 1338-1347. With broadband lambda probes, in particular with planar broadband lambda probes, it is, for example, possible to determine the oxygen concentration in the exhaust gas in a large range and thus to deduce the air-fuel ratio in the combustion chamber. The air number 1 (lambda) describes this air-fuel ratio. Nitrogen oxide sensors determine both the nitrogen oxide concentration and the oxygen concentration in the exhaust gas.

By combining a pump cell, the measurement cell, and an oxygen reference cell, i.e., the Nernst cell, a sensor for measuring the oxygen content in an ambient gas can be constructed. In a pump cell operating according to the amperometric pump principle, when a voltage or current is applied to the pump electrodes, which are located at different gases, an oxygen ion current diffuses through a ceramic body (the oxygen-conducting solid electrolyte), which separates the gases from one another (“pumping”). If the pump cell is used to keep the oxygen partial pressure constant in a cavity into which ambient gas can diffuse, the measurement of the electrical current can be used to deduce the transported amount of oxygen. According to the law of diffusion, this pump current is directly proportional to the oxygen partial pressure in the ambient gas. With a Nernst cell, the ratio of the oxygen partial pressure in the cavity to the oxygen partial pressure in a further reference gas chamber can be determined via the forming Nernst voltage.

The electrochemical unit of such a sensor may be considered a control path in a control loop. The control variable of this control loop is the voltage or, optionally, the current at the pair of pump electrodes. The controlled variable is the Nernst voltage that is measured. The aim of the control is to keep the oxygen partial pressure in the cavity as close as possible to a specified or given value despite changes in the oxygen content in the exhaust gas. The Nernst voltage is used to measure the oxygen partial pressure in the cavity or the ratio of the oxygen partial pressure in the cavity to the partial pressure in the reference cell. The voltage applied to the pair of pump electrodes can be used to control the oxygen partial pressure in the cavity. By transporting oxygen ions into or out of the cavity, which is also referred to as pumping, the gas concentration can be actively influenced via the applied pump voltage or the pump current. All electrodes in the cavity have a common return conductor. In order to be able to represent negative voltages as well, this virtual mass is at an increased potential relative to the electrical ground. The Nernst voltage and the voltage at the first electrode are referenced to this voltage.

For determining the oxygen partial pressure, or the oxygen content, a pump current signal, which is approximately linear to the oxygen concentration present in the ambient gas, is evaluated in the case of broadband lambda probes and nitrogen oxide sensors.

In a lambda-controlled combustion engine, e.g., a gasoline engine with a three-way exhaust gas catalytic converter and a lambda probe, the air-fuel ratio in homogeneous operation is controlled by the lambda control such that the average lambda value of the mixture composition for all cylinders has the value lambda=1.0 and thus ensures low-emission operation.

Due to the metering tolerances in the fuel metering of the combustion engine, which, for example, takes place by means of injectors or injection valves, and due to cylinder-specific differences caused by system tolerances in the mixture composition, i.e., the cylinder filling with fuel and air, an uneven distribution of the lambda values of individual cylinders occurs, although the average value for all cylinders assumes the desired lambda value 1.0. For example, in a four-cylinder engine, it may be that lambda (Zyl.1)=1.1, lambda (Zyl.2)=1.1, lambda (Zyl.3)=1.1, and lambda (Zyl.4)=0.7, which overall corresponds to an average value of lambda=1.0.

This uneven distribution between the individual cylinders leads to a reduced service life of the components since, for example, strong pulses act on the crankshaft when the over-fueled cylinder ignites. The applicable legislation in many countries therefore requires exhaust gas diagnostic strategies or control strategies that counteract or prevent this uneven distribution.

Germany Patent Application No. DE 195 27 218 A1 describes a generic method in which a possible uneven distribution of cylinder lambda values is derived from uneven running of the combustion engine, i.e., the change in engine torque after abrupt leaning. The underlying technical effect there is that a clear relationship exists between the mixture composition and a crankshaft acceleration resulting from the combustion. Cylinder-specific lambda differences of individual cylinders are adjusted in that the cylinder mixture compositions are leaned one after the other and a cylinder-specific feature for enriching the respective cylinder mixture composition is derived from the detected change in uneven running. Simultaneously enriching the non-leaned cylinder mixture compositions ensures that the average value of lambda for all cylinders is constant at 1.0.

Despite the advantages these sensors and methods bring about for their function control, they still have potential for improvement. For example, current algorithms for detecting cylinder-specific enriching show weaknesses when a jitter, i.e., a variable component of the latency, is present in the underlying pump current signal at the lambda sensor, since the jitter creates an uncertainty range which, at certain speeds and with certain jitter, can lead to multiple cylinders coming into consideration for the present enriching. Determining the over-fueled cylinder is thus not always reliably possible. In conventional lambda detection systems, a relevant part of the jitter is generated by the evaluation electronics if the data are, for example, received in an interrupt-controlled manner, then further processed as a packet and finally transmitted in a standard grid to the users.

### SUMMARY

The present invention provides a method for operating a sensor for detecting at least one property of a measured gas in a measurement gas chamber, which at least largely avoids the disadvantages of conventional methods for operating these sensors and which is in particular suitable to eliminate a jitter component from the signal and thus to provide the basis for reliable cylinder-specific enrichment detection.

A method according to an example embodiment of the present invention for operating a sensor for detecting at least one property of a measured gas in a measurement gas chamber, in particular for detecting a fraction of a gas component in the measured gas, wherein the sensor comprises a sensor element for detecting the property of the measured gas, wherein the sensor element comprises at least one Nernst cell, comprises the following steps, preferably in the order given:
measuring a Nernst voltage of the Nernst cell and, on the basis of the Nernst voltage, quantitatively determining a target variable describing the property of the measured gas;
recording a target variable data packet on the basis of the target variable;
assigning a current timestamp to the target variable data packet;
processing the target variable data packet on a signal processing path;
requesting a current system time;
correcting the timestamp of the currently processed target variable packet on the basis of a predetermined time delay and the current system time;
converting the corrected timestamp to form a number of measured values;
ascertaining a time correction index for the target variable on the basis of the number of measured values; and
ascertaining a corrected target variable value on the basis of the time correction index.

At the time of detection of the measured value, for example, in the basic software of the control device, a newly introduced timestamp is thus recorded in addition to the already existing measured values, for example the Nernst voltage or variables, such as pump current values, derived therefrom. The measured values are written with the associated timestamp into a ring buffer. In the software portion that provides the signal to the user software, the measured value is taken from the ring buffer, which is delayed by a certain time offset in comparison to the current system time. This time offset is greater than the possible worst-case delay by the jitter. The variable portion of the time delay (the jitter) is thus eliminated.

The target variable may be the Nernst voltage itself or a variable derived therefrom. The method may thus correct either the Nernst voltage or measured variables derived therefrom.

According to an example embodiment of the present invention, the sensor element may furthermore comprise a pump cell. The target variable may be a manipulated variable when controlling the Nernst voltage, and this manipulated variable may be a current or a voltage of a pump cell of the sensor element or of the Nernst cell. Accordingly, the method is in particular applicable to spring probes or broadband lambda probes.

The predetermined time delay may be constant. On the basis of a known constant variable, the jitter can thus be eliminated particularly reliably.

The predetermined time delay may be greater than a delay in the processing of the target variable data packet on the signal processing path. This constant time offset is greater than the possible worst-case delay by the jitter. The variable portion of the time delay (the jitter) is thus eliminated.

According to an example embodiment of the present invention, correcting the timestamp may comprise adding the predetermined time delay to and subtracting the current system time from the timestamp. This allows the timestamp to be reliably and correctly corrected by simple calculations.

According to an example embodiment of the present invention, the method may furthermore comprise storing target variable data packets with the assigned timestamp in a memory. This allows the values to be used multiple times.

The signal processing path may be part of user software. The user software may comprise a ring buffer. Access is thus possible quickly and multiple times since the measured values with the associated timestamp are written into the ring buffer, and the measured value can be taken from the ring buffer in the software portion that provides the signal to the user software.

According to an example embodiment of the present invention, ascertaining the corrected target variable value on the basis of the time correction index may comprise accessing a target variable data packet stored in the ring buffer, starting from a lastly stored target variable data packet. The correction can thus be made on the basis of a last known measured value, for example a pump current value.

The corrected target variable value may be ascertained by subtracting the correction index from the index of the lastly stored target variable data packet. The correction can thus be made by simple calculation.

According to an example embodiment of the present invention, recording the target variable data packet may take place at a higher clock speed than requesting the current system time. The measured values are thus recorded more frequently than the system time is requested, so that a sufficient number of measured values is provided for the method.

The present invention also relates to a sensor for detecting at least one property of a measured gas in a measurement gas chamber, in particular for detecting a fraction of a gas component in the measured gas or a temperature of the measured gas, comprising a sensor element for detecting the property of the measured gas, wherein the sensor element comprises at least one Nernst cell, wherein the sensor assembly furthermore comprises an electronic control device with the computer program according to the present invention for carrying out the method according to the present invention.

For example, the sensor element comprises a solid electrolyte, a first electrode, a second electrode, a third electrode, and a fourth electrode, wherein the first electrode and the second electrode are connected to the solid electrolyte such that the first electrode, the second electrode and the solid electrolyte form a pump cell, wherein the third electrode and the fourth electrode are connected to the solid electrolyte such that the third electrode, the fourth electrode and the solid electrolyte form a Nernst cell.

In the context of the present invention, the term “solid electrolyte” is understood to mean a body or object with electrolytic properties, i.e., ion-conductive properties. In particular, it may be a ceramic solid electrolyte. This also includes the raw material of a solid electrolyte and therefore the formation as a so-called green body or brown body, which only becomes a solid electrolyte after sintering. In particular, the solid electrolyte may be formed as a solid electrolyte layer or of a plurality of solid electrolyte layers. In the context of the present invention, the term “layer” is understood to mean a uniform mass with a laminar extent of a certain height that lies above, below or between other elements.

In the context of the present invention, the term “electrode” is understood in general to mean an element capable of contacting the solid electrolyte such that a current through the solid electrolyte and the electrode can be maintained. Accordingly, the electrode may comprise an element at which the ions can be incorporated into the solid electrolyte and/or removed from the solid electrolyte. Typically, the electrodes comprise a precious metal electrode, which may, for example, be applied as a metal-ceramic electrode to the solid electrolyte or may otherwise be connected to the solid electrolyte. Typical electrode materials are platinum-cermet electrodes. However, other precious metals, such as gold or palladium, are in principle also usable.

In the context of the present invention, the term “heating element” is understood to mean an element that serves to heat the solid electrolyte and the electrodes to at least their functional temperature and preferably to their operating temperature. The functional temperature is the temperature from which the solid electrolyte becomes ion-conducting, and is approximately 350° C. This must be distinguished from the operating temperature, at which the sensor element usually operates and which is higher than the functional temperature. For example, the operating temperature may be 700° C. to 950° C. The heating element may comprise a heating area and at least one supply path. In the context of the present invention, the term “heating area” is understood to mean the area of the heating element that overlaps with an electrode in the layer structure along a direction perpendicular to the surface of the sensor element. During operation, the heating area usually heats up more strongly than the supply path so that they are distinguishable. The different heating may, for example, be realized in that the heating area has a higher electrical resistance than the supply path. The heating area and/or the supply line are, for example, designed as an electrical resistive path and heat up by applying an electrical voltage. For example, the heating element may be made from a platinum-cermet.

In the context of the present invention, the term “control loop” is understood to mean a closed operational sequence for influencing a physical variable in a technical process. The essential part in this respect is the return of the current value, which is also referred to as the actual value, to the control unit, which continuously counteracts a deviation from the target value. The control loop consists of the control path, the control unit, and negative feedback of the actual value as the controlled variable. The controlled variable is compared to the target value as a reference variable. The control deviation between the actual value and the target value is supplied to the control unit, which forms a control variable for the control path therefrom according to the desired dynamics of the control loop. In the context of the present invention, the term “control path” is understood to mean the part of the control loop that contains the controlled variable on which the control unit is to act via the control variable or manipulated variable. In the context of the present invention, the electrochemical unit of the sensor is the control path.

In the context of the present invention, the term “measured variable” is understood in principle to mean any physical and/or chemical variable and a signal equivalently indicating this/these variable(s), i.e., an equivalent signal. Preferably, the measured variable is at least one measurement signal of the sensor element. Preferably, the measured variable may be at least one pump current, for example a limiting current. However, the measured variable may also be a variable dependent on the pump current. For example, the measured variable may be a pump voltage and/or a converted charge. In the context of the present invention, the term “detected” in this respect is understood to mean that the measured variable is output, for example as a measurement signal, by the sensor element and/or that the measured variable is processed and/or evaluated and/or stored by a control device.

In the context of the present invention, the term “latency” is understood in general to mean the transmission time of a signal. The term “transmission time” is understood to mean the time difference between the entry of a signal into a (causal) system and the exit. In particular, latency is the time interval by which an event is delayed. The processing delay is determined by the time required to further process the signal. It can be reduced by using more computing power. Latency refers in particular to the transmission time of information (data packet) from its source to the destination. Latencies are measured in round-trip time (RTT). The RTT value is double the latency value. RTT values above 100 ms are no longer acceptable for daily work; for real-time applications, this value should be as small as possible. However, it should be noted that even greater latencies may be accepted for the present invention, and only the jitter poses a problem since the signals repeat periodically at constant speed. Lag times arise, for example, as a result of: the transmission time of the signals in a transmission medium (copper, glass, etc.), the transmission time of a packet over the individual subpaths with a limited bandwidth, the processing of the packets by the network components involved, the queues as a result of congestions in individual subpaths or properties of the transmission protocol (UDP, TCO, RTP, etc.)

In the context of the present invention, the term “jitter” is understood in general to mean to the variance in the transmission time of the individual data packages. The variance resulting from the different travel time of the gas packets to the probe at different speeds must be eliminated by means of characteristic maps. However, in contrast to the jitter in signal processing, these travel time differences are constant and reproducible since the occurrence of a peak in the signal at the probe can be assigned to a particular cylinder for each speed at a particular crankshaft angle. The effect of the variance in the transmission time of the individual data packets is very disruptive in real-time applications on the Internet (such as Internet radio, VOIP, video applications, process controls, etc.) since it can result in data packets possibly arriving too late to be considered in time. Jitter is reduced by a so-called jitter buffer, but at the cost of further increasing the latency. Jitter is also referred to as the temporal clock jitter in the transmission of digital signals, a slight variation in accuracy in the transmission clock. Jitter is normally undesirable as an interference signal. More generally, jitter in transmission technology is an abrupt and undesirable change in signal characteristic. This may relate both to the amplitude and to the frequency and phase position. The jitter is the first derivative of a delay. The spectral representation of the temporal deviations is referred to as phase noise. Jitter is not to be confused with quantization errors.

Latencies and jitter are crucial, especially to real-time applications. Poor latency values and jitter values affect the quality of the data transmission, i.e., the packet transmission time as such is too long or individual packets arrive with delays, which in turn leads to information loss.

### BRIEF DESCRIPTION OF THE DRAWINGS

Further optional details and features of the present invention emerge from the following description of preferred embodiment examples, which are shown schematically in the figures.

FIG. 1 shows a principal structure of a sensor according to an example embodiment of the present invention.

FIG. 2 shows a schematic illustration of a flow of the method according to an example embodiment of the present invention.

FIG. 3 shows a block diagram of the storing process for pump current values, according to an example embodiment of the present invention.

FIG. 4 shows a block diagram of the calculation of the correction index, according to an example embodiment of the present invention.

FIG. 5 shows a table with exemplary calculation quantities for the method according to an example embodiment of the present invention.

### DETAILED DESCRIPTION OF EXAMPLE EMBODIMENTS

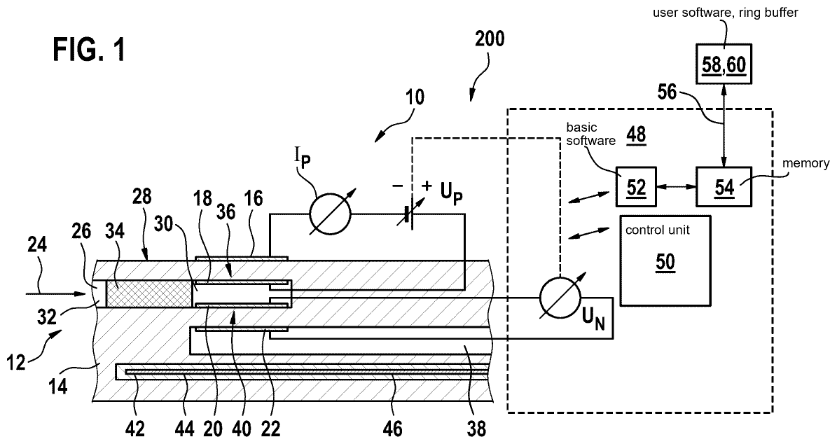

FIG. 1 shows a principal structure of a sensor 10 according to the present invention. The sensor 10 shown in FIG. 1 may be used to detect physical and/or chemical properties of a measured gas, wherein one or more properties may be detected. The present invention is described below in particular with reference to a qualitative and/or quantitative detection of a gas component of the measured gas, in particular with reference to a detection of an oxygen fraction in the measured gas. For example, the oxygen fraction may be detected in the form of a partial pressure and/or in the form of a percentage. However, other types of gas components may in principle also be detected, such as nitrogen oxides, hydrocarbons, and/or hydrogen. Alternatively or additionally, however, other properties of the measured gas can also be detected. The present invention can in particular be used in the field of automotive technology so that the measurement gas chamber may in particular be an exhaust tract of a combustion engine and the measured gas may in particular be an exhaust gas. For example, the sensor 10 is designed as a lambda probe, in particular as a broadband lambda probe, as explained in more detail below. However, it is explicitly emphasized that the sensor 10 may alternatively be a spring probe.

The sensor 10 comprises a sensor element 12. The sensor element 12 may be designed as a ceramic layer structure, as described in more detail below. The sensor element 12 comprises a solid electrolyte 14, a first electrode 16, a second electrode 18, a third electrode 20, and a fourth electrode 22. Solid electrolyte 14 may be composed of a plurality of ceramic layers in the form of solid electrolyte layers or may comprise a plurality of solid electrolyte layers. For example, the solid electrolyte 14 comprises a pump film or pump layer, an intermediate film or intermediate layer, and a heating film or heating layer, which are arranged one above the other or one below the other. The designation of the electrodes 16, 18, 20, 22 is not intended to indicate a weighting of their importance, but merely to distinguish them terminologically.

The sensor element 12 furthermore comprises a gas entry path 24. The gas entry path 24 comprises a gas entry hole 26 extending from a surface 28 of the solid electrolyte 14 into the interior of the layer structure of the sensor element 12. Provided in the solid electrolyte 14 is an electrode cavity 30, which surrounds the gas entry hole 26, for example annularly or rectangularly. The electrode cavity 30 is part of the gas entry path 24 and is connected to the measurement gas chamber via the gas entry hole 26. For example, the gas entry hole 26 extends as a cylindrical blind hole perpendicularly to the surface 28 of the solid electrolyte 14 into the interior of the layer structure of the sensor element 12. In particular, the electrode cavity 30 is substantially annular or rectangular and is bounded by the solid electrolyte 14 from three sides when viewed in a cross-sectional view. A channel 32 is arranged between the gas entry hole 26 and the electrode cavity 30 and is likewise a component part of the gas entry path 24. Arranged in this channel 32 is a diffusion barrier 34, which reduces or even prevents gas from flowing from the measurement gas chamber into the electrode cavity 30 and only makes diffusion possible.

The first electrode 16 is arranged on the surface 28 of the solid electrolyte 14. The first electrode 16 may annularly surround the gas entry hole 26 and be separated from the measurement gas chamber, for example by a gas-permeable protection layer (not shown in detail). The second electrode 18 is arranged in the electrode cavity 30. The second electrode 18 may likewise be annular and arranged rotationally symmetrically around the gas entry hole 26. For example, the first electrode 16 and the second electrode 18 are arranged coaxially with the gas entry hole 26. The first electrode 16 and the second electrode 18 are connected, in particular electrically connected, to the solid electrolyte 14 and in particular to the pump layer such that the first electrode 16, the second electrode 18 and the solid electrolyte 14 form a pump cell 36. Accordingly, the first electrode 16 may also be referred to as an outer pump electrode and the second electrode 18 may be referred to as an inner pump electrode. A limiting current of the pump cell 36 can be adjusted via the diffusion barrier 34. The limiting current thus represents a current flow between the first electrode 16 and the second electrode 18 via the solid electrolyte 14.

The sensor element 12 furthermore comprises a reference gas chamber 38. The reference gas chamber 38 may extend perpendicularly to a direction of extent of the gas entry hole 26 into the interior of the solid electrolyte 14. As mentioned above, the gas entry hole 26 is cylindrical so that the direction of extent of the gas entry hole 26 is parallel to a cylinder axis of the gas entry hole 26. In this case, the reference gas chamber 38 extends perpendicularly to the cylinder axis of the gas entry hole 26. It is expressly mentioned that the reference gas chamber 38 may also be arranged in an imaginary extension of the gas entry hole 26 and thus further inside the solid electrolyte 14. The reference gas chamber 38 need not be designed as a macroscopic reference gas chamber. For example, the reference gas chamber 38 may be designed as a so-called pumped reference, i.e., as an artificial reference.

The third electrode 20 is likewise arranged in the electrode cavity 30. For example, the third electrode 20 is located opposite the second electrode 18. The fourth electrode 22 is arranged in the reference gas chamber 38. The third electrode 20 and the fourth electrode 22 are connected to the solid electrolyte 14 such that the third electrode 20, the fourth electrode 22, and the portion of the solid electrolyte 14 between the third electrode 22 and the fourth electrode 22 form a Nernst cell 40. By means of the pump cell 36, a pump current through the pump cell 36 may, for example, be adjusted such that the condition λ (lambda)=1 or another known composition prevails in the electrode cavity 30. This composition, in turn, is detected by the Nernst cell 40 in that a Nernst voltage Uᵥₛ between the third electrode 20 and the fourth electrode 22 is measured. Since a known gas composition is present in the reference gas chamber 38 or said gas composition is exposed to an excess of oxygen, the measured voltage can be used to deduce the composition in the electrode cavity 30.

In the extension of the direction of extent of the gas entry hole 26, a heating element 42 is arranged in the layer structure of the sensor element 12. The heating element 42 has a heating area 44 and electrical supply paths 46. The heating area 44 is designed to be meandering, for example. The heating element 42 is arranged in the solid electrolyte 14 between the intermediate layer and the heating layer. It is expressly mentioned that the heating element 42 is surrounded on both sides by a thin layer of an electrically insulating material, for example aluminum oxide, even if this is not shown in more detail in the figures. In other words, the thin layer of the electrically insulating material is arranged between the intermediate layer and the heating element 42 and also between the heating element 42 and the heating layer. Since such a layer is, for example, as described in the aforementioned related art, it is not described in more detail. For further details regarding the layer of electrically insulating material, reference is therefore made to the aforementioned prior art, whose content relating to the layer of electrical material is incorporated here by reference.

As shown in FIG. 1, the sensor 10 is connected to an electronic control device 48. The electronic control device 48 comprises a control unit 50 for controlling a Nernst voltage U_{N} of the Nernst cell 40. The sensor 10 and the control device 48 are part of a sensor assembly 200. The pump voltage U_{P} applied to the pump cell 36 represents the manipulated variable of the electronic control device 48 for controlling the Nernst voltage U_{N}. In this case, the Nernst voltage U_{N} is the controlled variable at the same time. In this way, the pump current I_{P}, which depends on the oxygen concentration, flows into or out of the pump cell 36 and indicates the oxygen content, can additionally be determined.

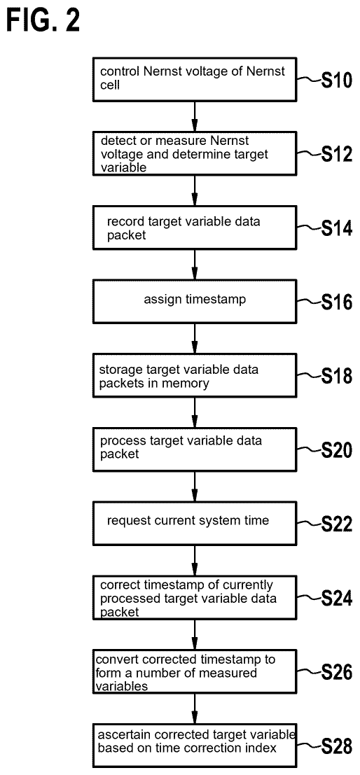

FIG. 2 shows a schematic illustration of a flow of a method according to the present invention for operating the sensor 10. The method makes reliable cylinder-specific enrichment detection possible by eliminating a jitter component from a pump current signal.

In step S10, in a conventional manner and described above, a Nernst voltage U_{N} of the Nernst cell 40 is controlled according to a first reference variable. A pump current or a pump voltage of the pump cell 36 is used as the manipulated variable. Without being limited thereto, the method is in particular described with reference to the pump current Ip as the manipulated variable. If the sensor 10 is a spring probe, step S10 can be omitted. In step S12, the Nernst voltage U_{N} of the Nernst cell 40 is detected or measured and a target variable describing the property of the measured gas is quantitatively determined. The target variable is the Nernst voltage U_{N} itself or a variable derived therefrom. In particular, the manipulated variable signal is a pump current signal, the measured values of which are detected or derived from the Nernst voltage U_{N}. In step S14, a target variable data packet is recorded on the basis of the target variable. Such a target variable data packet comprises a plurality of target variable values, such as 5 pump current values. The detection of the measured values is, for example, recorded in a basic software 52 of the control device 48 (FIG. 1). In step S16, a timestamp is assigned to the target variable data packet. In other words, at the time of detection of the measured values, a timestamp to be newly introduced is recorded in addition to the already existing pump current values. Recording is carried out by storing in a memory 54 of the basic software 52 of the control device 48. In step S18, target variable data packets are stored with the assigned timestamp in the memory 54. In other words, the pump current measured values are written with the associated timestamp into the memory 54.

In a subsequent step S20, the target variable data packet is processed on a signal processing path 56. In other words, the pump current packet passes through the signal processing path 56, where different time delays may occur for various reasons. For example, new values are requested every 2 ms, but new values are provided to the basic software 52 of the control device 48 only every 2.5 ms. The signal processing path 56 is part of user software 58. The user software 58 may be implemented on an external control device (not shown in detail), such as the engine controller. A portion of the signal processing, namely, speed-synchronous filtering, is carried out in the user software 58. The user software 58 comprises a ring buffer 60, into which the measured values with the associated timestamp are written.

In step S22, a current system time is requested. The system time is requested by the basic software 52. This system time is ahead of the currently processed pump current packet by the current latency. The target variable data packet is recorded at a higher clock speed than the current system time is requested. For example, the target variable is measured every 500 μs, and the system time is requested every 2 ms. For this reason, in a step S24, the timestamp of the currently processed target variable data packet is corrected on the basis of a predetermined time delay and the current system time. The predetermined time delay is greater than a delay in the processing of the target variable data packet on the signal processing path, i.e., the constant time offset is greater than the possible total worst-case delay. The predetermined time delay is constant. Correcting the timestamp comprises adding the timestamp assigned to the currently processed pump current packet to the current system time and subtracting the current system time from the timestamp. In other words, the defined constant time delay is accordingly added to the timestamp of the currently processed pump current packet and the current system time is subtracted.

In step S26, the corrected timestamp is converted to form a number of measured values. The value of time expressed in a unit of time is thus converted into a number of measured values, which is the factor 2 in the above example since there are 2 pump current values per 1 ms. A time correction index for the target variable is ascertained on the basis of the number of measured values. Then, in step S28, a corrected target variable value is ascertained on the basis of the time correction index. Ascertaining the corrected target variable value on the basis of the time correction index comprises accessing a target variable data packet stored in the ring buffer 60, starting from a lastly stored target variable data packet. The corrected target variable value is ascertained by subtracting the correction index from the index of the lastly stored target variable data packet. Converting the time value for the timestamp into the number of measured values thus results in a difference in the index by which jumping backward in the ring buffer 60 must occur in comparison to the last target variable value present. Historical target variable values are saved in the ring buffer 60 itself such that the time offset backward does not result in accessing values that are already overwritten. This is ensured via a suitable buffer size. In the above example, when processing in the 2 ms grid, this method provides constant incrementing of the index of the ring buffer 60 by 4 in each function call, which results from 4 target variable values per 2 ms. Constant incrementing ensures that the signal is jitter-free. This is made possible by introducing the constant time delay, which does however not bring about any disadvantages for common applications of cylinder-specific enrichment detection. The algorithm also works if the function that provides the data for the user function and the function that stores the data in the ring buffer 60 are called up in different grids.

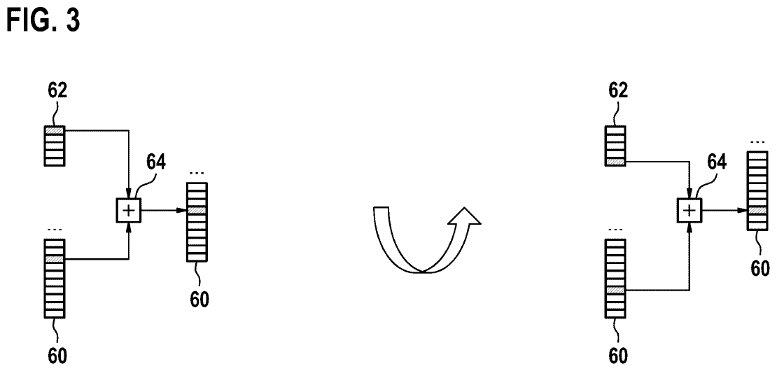

FIG. 3 shows a block diagram of the storing process for pump current values as target variable values by way of example. The left part of FIG. 3 shows the ring buffer 60, which contains stored pump current values. Only by way of example is a pump current value indicated at position 3 of the ring buffer 60. As explained above, new pump current values are detected and recorded, as indicated, for example, as a target variable data packet or pump current data packet in the form of an array 62 from the basic software 52 at position 1. The new pump current values are written into the ring buffer 60 as indicated by an addition block 64. In doing so, the sum of the previous value, i.e., at position 3 of the ring buffer 60 in the above example, and the new value, i.e., the pump current data packet at position 1 in the above example, is always saved as a new value in the ring buffer 60. Accordingly, the new pump current value is subsequently located at position 4 in the ring buffer 60.

These storing steps may be repeated n times, for example in a 2 ms grid. Here, n is a whole number. The right part of FIG. 3 shows the storing process after four repetitions. The lower right part of FIG. 3 thus indicates, by way of example, a pump current value at position 7 of the ring buffer 60. As explained above, new pump current values are detected, as indicated in a, for example in the, array at position 5. The sum of the current value of the pump current packet 62 (at position 5 in the example) and the old value of the ring buffer 60 is written to the new position of the ring buffer 60 (at position 8 in the example).

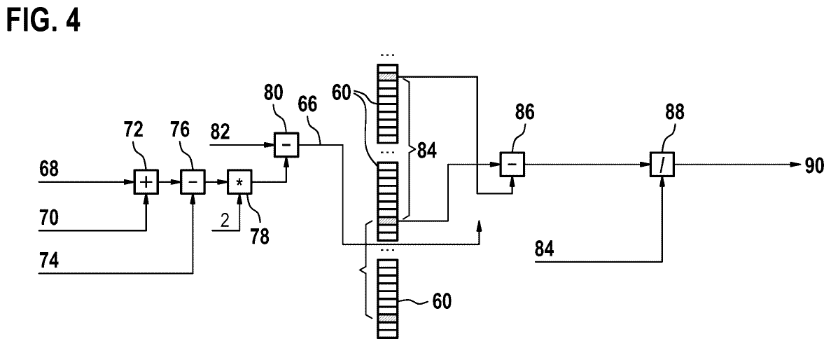

FIG. 4 shows a block diagram of the calculation of the correction index, likewise by way of example for the pump current as the target variable. The block diagram is shown in accordance with the AUTOSAR standard. Shown to the left of the array 62 or the ring buffer 60 is the calculation of the correction index, i.e., index shift. For reasons of clarity, the array 62 is shown divided since it is a very large array and may, for example, comprise 192 values. The output variable for the correction index is denoted by 66. The defined constant time delay 70 is added to the timestamp 68 of the currently processed pump current packet, as shown by an addition block 72, and the current system time 74 is subtracted, as shown by a subtraction block 76. This value of time, expressed in a unit of time, is converted into a number of measured values. Referring to the example above, this is done through a factor 2, due to 2 pump current values per 1 ms, as shown by a multiplication block 78. This results in a difference, as shown by a subtraction block 80, in the index on the basis of the current index 82 of the ring buffer 60, by which jumping backward in the ring buffer 60 must occur in comparison to the last available pump current value. With this index, a segment-synchronous average value formation starts. The number of array elements required for the average value formation is denoted by 84.

Since the sum of the previous and the new value is always saved in the array, the start of the segment must still be deducted at the end, as shown by a subtraction block 86, and, for final average value formation, division by the number of summed values 84 must occur, as shown by a division block 88, wherein both calculations are shown to the right of the ring buffer 60. The corrected target variable value 90 is then finally ascertained therefrom as the corrected pump current value. Since the used number of array elements 84 can be changed and historical target variable values are stored in the ring buffer 60 for a sufficient amount of time, ascertaining the corrected pump current value as the target variable value 90 can take place in a different grid than both reading and sending the pump current packets as the target variable data packets 62.

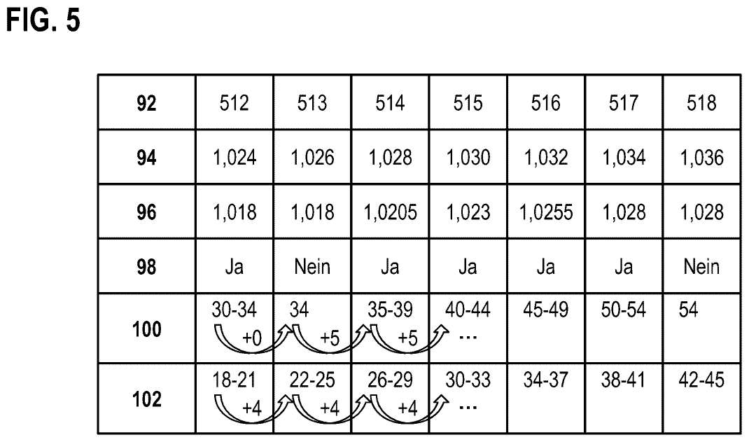

FIG. 5 shows a table with exemplary calculation quantities for the method according to the present invention. In particular, reference is made to the aforementioned example, in that the pump current packets as target variable data packets are requested at a different clock speed than the pump current packets are sent as target variable data packets. In the first row, the step numbers 92 of the signal request for the pump current are shown. In the second row, the timestamp of the basic software 94, which indicates the current system time, is shown in s. In the third row, the timestamp of the current pump current data packet 96 is shown in s. In the fourth row, obtaining a pump current value 98 is shown as Yes/No. In the fifth row, the current index of the pump current array 100 is shown. In the sixth row, the array element 102 considered for the calculation is shown. The table also shows the exemplary calculation according to FIG. 4.

1-14. (canceled)

15. A method for operating a sensor for detecting at least one property of a measured gas in a measurement gas chamber, wherein the sensor includes a sensor element configured to detect the property of the measured gas, wherein the sensor element includes at least one Nernst cell, and wherein the method comprises the following steps:
measuring a Nernst voltage of the Nernst cell, and, based on the Nernst voltage, quantitatively determining a target variable describing the property of the measured gas;
recording a target variable data packet based on the target variable;
assigning a current timestamp to the target variable data packet;
processing the target variable data packet on a signal processing path;
requesting a current system time;
correcting the timestamp of the currently processed target variable data packet based on a predetermined time delay and the current system time;
converting the corrected timestamp to form a number of measured values;
ascertaining a time correction index for the target variable based on the number of measured values; and
ascertaining a corrected target variable value based on the time correction index.

16. The method according to claim 15, wherein the target variable is the Nernst voltage or a variable derived from the Nernst voltage.

17. The method according to claim 15 wherein the target variable is a manipulated variable when controlling the Nernst voltage, and the manipulated variable is a current or a voltage of a pump cell of the sensor element or of the Nernst cell.

18. The method according to claim 15, wherein the predetermined time delay is constant.

19. The method according to claim 15, wherein the predetermined time delay is greater than a delay in the processing of the target variable data packet on the signal processing path.

20. The method according to claim 15, wherein the correcting of the timestamp includes adding the timestamp assigned to the currently processed pump current packet to and subtracting the current system time from the timestamp.

21. The method according to claim 15, further comprising storing target variable data packets with the assigned timestamp in a memory.

22. The method according to claim 15, wherein the signal processing path is part of user software, wherein the user software includes a ring buffer.

23. The method according to claim 15, wherein the ascertaining of the corrected target variable value based on the time correction index includes accessing a target variable data packet stored in the ring buffer, starting from a target variable data packet lastly stored in the ring buffer.

24. The method according to the 23 wherein the corrected target variable value is ascertained by subtracting the correction index from the lastly stored target variable data packet.

25. An electronic storage medium on which is stored a computer program for operating a sensor for detecting at least one property of a measured gas in a measurement gas chamber, wherein the sensor includes a sensor element configured to detect the property of the measured gas, wherein the sensor element includes at least one Nernst cell, and wherein the computer program, when executed by a computer, cause the computer to perform the following steps:
measuring a Nernst voltage of the Nernst cell, and, based on the Nernst voltage, quantitatively determining a target variable describing the property of the measured gas;
recording a target variable data packet based on the target variable;
assigning a current timestamp to the target variable data packet;
processing the target variable data packet on a signal processing path;
requesting a current system time;
correcting the timestamp of the currently processed target variable data packet based on a predetermined time delay and the current system time;
converting the corrected timestamp to form a number of measured values;
ascertaining a time correction index for the target variable based on the number of measured values; and
ascertaining a corrected target variable value based on the time correction index.

26. An electronic control device, comprising:
an electronic storage medium on which is stored a computer program for operating a sensor for detecting at least one property of a measured gas in a measurement gas chamber, wherein the sensor includes a sensor element configured to detect the property of the measured gas, wherein the sensor element includes at least one Nernst cell, and wherein the computer program, when executed by the electronic control device, cause the electronic control device to perform the following steps:
measuring a Nernst voltage of the Nernst cell, and, based on the Nernst voltage, quantitatively determining a target variable describing the property of the measured gas;
recording a target variable data packet based on the target variable;
assigning a current timestamp to the target variable data packet;
processing the target variable data packet on a signal processing path;
requesting a current system time;
correcting the timestamp of the currently processed target variable data packet based on a predetermined time delay and the current system time;
converting the corrected timestamp to form a number of measured values;
ascertaining a time correction index for the target variable based on the number of measured values; and
ascertaining a corrected target variable value based on the time correction index.

27. A sensor assembly, comprising:
a sensor configured to detect at least one property of a measured gas in a measurement gas chamber, the sensor including a sensor element configured to detect the property of the measured gas, wherein the sensor element includes at least one Nernst cell; and
an electronic control device including an electronic storage medium on which is stored a computer program for operating a sensor for detecting at least one property of a measured gas in a measurement gas chamber, wherein the sensor includes a sensor element configured to detect the property of the measured gas, wherein the sensor element includes at least one Nernst cell, and wherein the computer program, when executed by the electronic control device, cause the electronic control device to perform the following steps:
measuring a Nernst voltage of the Nernst cell, and, based on the Nernst voltage, quantitatively determining a target variable describing the property of the measured gas;
recording a target variable data packet based on the target variable;
assigning a current timestamp to the target variable data packet;
processing the target variable data packet on a signal processing path;
requesting a current system time;
correcting the timestamp of the currently processed target variable data packet based on a predetermined time delay and the current system time;
converting the corrected timestamp to form a number of measured values;
ascertaining a time correction index for the target variable based on the number of measured values; and
ascertaining a corrected target variable value based on the time correction index.
